(19) United States
(12) Patent Application Publication
(10) Pub. No.: US 2026/0340100 A1
(43) Pub. Date: Oct. 29, 2026

(54) Methods of Controlling Access to and Presenting Content in a Document File

(71) Applicant: Leonard L. Drey, St. Louis, MO (US)

(72) Inventor: Leonard L. Drey, St. Louis, MO (US)

(21) Appl. No.: 19/468,360

(22) Filed: Feb. 3, 2026

Related U.S. Application Data
(60) Provisional application No. 63/754,096, filed on Feb. 5, 2025.

(51) Int. Cl. G06F 21/34; G06F 21/62

(52) U.S. Cl. CPC G06F 21/34; G06F 21/6218

(57) ABSTRACT

A method of recovering units of publication that have become inaccessible to a user who acquired the units of publication using an original authorization code includes providing, by the user to a publisher via the publisher's website, an email address to which the original authorization code was sent by the publisher. The user provides the original authorization code, as well as a backup copy of the inaccessible units, to the publisher via the publisher's website. The user requests inactivation and replacement of the inaccessible units to the publisher, and receives a new authorization code. A storage device is registered using the new authorization code and a universal global identifier for the device. The user requests inactivation and replacement of the units. A confirmation code is provided by the publisher, which the user enters at the publisher's website. The publisher inactivates the inaccessible units, and provides replacement units to the user.

### CROSS-REFERENCE TO RELATED APPLICATIONS

This is related to, and claims priority from, U.S. Provisional Application for Patent No. 63/754,096, which was filed on Feb. 5, 2025, the disclosure of which is incorporated herein in its entirety.

This subject matter is related to the substance of the following patent applications, the entire disclosures of which are incorporated herein by this reference.
1. U.S. Provisional Application for Patent No. 63/715,974, filed on Nov. 4, 2024 (Leonard L. Drey, applicant). [Title: “Methods of Controlling Access to and Presenting Content in a Document File”]
2. U.S. Provisional Application for Patent No. 63/667,308, filed on Jul. 3, 2024 (Leonard L. Drey, applicant). [Title: “Methods of Controlling Access to and Presenting Content in a Document File”]
3. U.S. Provisional Application for Patent No. 63/656,393, filed on Jun. 5, 2024 (Leonard L. Drey, applicant). [Title: “Inactivation and Reassignment of Inaccessible Working Files”]
4. U.S. patent application Ser. No. 18/638,648, filed on Apr. 17, 2024 (Leonard L. Drey, applicant). [Title: “Methods of Controlling Access to and Presenting Text and Images in a Document File”]
5. U.S. Provisional Application for Patent No. 63/463,956, filed on May 4, 2023 (Leonard L. Drey, applicant). [Title: “Method of Selective Online Dissemination of Digital Assets”]
6. U.S. Provisional Application for Patent No. 63/459,904, filed on Apr. 17, 2023 (Leonard L. Drey, applicant). [Title: “Method of Selective Online Dissemination of Digital Assets”]
7. U.S. patent application Ser. No. 17/585,076, filed on Jan. 26, 2022 (Leonard L. Drey, applicant). [Title: “Method of Selective Online Dissemination of Digital Assets”]
8. U.S. patent application Ser. No. 17/585,066, Publication No. 2023/0115858-A1 (published Apr. 13, 2023) (Leonard L. Drey, applicant). [Title: “Method of Selective Online Dissemination of Digital Assets”]
9. U.S. patent application Ser. No. 17/373,432, Publication No. 2022/0058242-A1 (published Feb. 24, 2022) (Leonard L. Drey, applicant). [Title: “System and Method of Governing Content Presentation of Multi-Page Electronic Documents”]
10. U.S. patent application Ser. No. 17/170,580, Publication No. 2022/0027486-A1 (published Jan. 27, 2022) (Leonard L. Drey, applicant). [Title: “System and Method of Controlling Access to a Document File”]
11. U.S. patent application Ser. No. 15/600,501, Publication No. 2017/0337354-A1 (published Nov. 23, 2017) (Leonard L. Drey, applicant). [Title: “Method of Governing Content Presentation and the Altering of Multi-Page Electronic Documents”]
12. U.S. patent application Ser. No. 14/524,694, Publication No. 2016/0267065-A1 (published Sep. 15, 2016) (Leonard L. Drey, applicant). [Title: “Method of Governing Content Presentation of Multi-Page Electronic Documents”]
13. U.S. patent application Ser. No. 14/965,855, Publication No. 2016/0140530-A1 (published May 19, 2016) (Leonard L. Drey, applicant). [Title: “Method of Governing Content Presentation and the Altering of Multi-Page Electronic Documents”]
14. U.S. patent application Ser. No. 12/965,421, Publication No. 2011/0313899-A1 (published Dec. 22, 2011) (Leonard L. Drey, applicant). [Title: “Method of Governing Content Presentation”]
15. U.S. patent application Ser. No. 11/620,512, Publication No. 2007/0157086-A1 (published Jul. 5, 2007) (Leonard L. Drey, applicant). [Title: “Time-Controlled Presentation of Content to a Viewer”]
16. U.S. patent application Ser. No. 18/638,648, filed Apr. 17, 2024) (Leonard L. Drey, applicant). [Title: “Methods of Controlling Access to and Presenting Text and Images in a Document File”]

### Field of the Invention

In general, the invention relates to methods of presenting content such as text and images to a viewer, for example, on a viewing device such as a processor display or a dedicated e-reader. According to different aspects of the invention, access to the content can be controlled, and, once accessed, presentation of the accessed content can be controlled as well.

### Background Of The Invention

There are many ways in which electronic content can be presented to a viewer. Such content can include a single type of content, such as text, images, or video, or multi-media content, such as content that includes text and images. Typically, the content is fixed and static, excepting certain formatting to adapt the content to the particular device on which the reader accesses the content. Such static presentation, which mimics a hard-copy document, does not take advantage of the great potential for novel presentation that could be made available to a reader, which would enhance the viewing experience and which would provide flexibility allowing authors and publishers to provide enhanced content to the marketplace.

Further, digital files and associated content are easily accessible and disseminated unless access controls are applied to the files and/or the file storage and dissemination system. Controlling all aspects of access to the files is important to limiting the consumption of and maintaining the integrity of the content.

The following novel aspects of the invention address these and other issues, in order to enhance the security and flexibility of a digital book publishing system (presented by way of example), although the concepts presented herein can be applied to any system for disseminating digital files, and the present invention is not limited to any particular application.

### SUMMARY OF THE INVENTION

According to an aspect of the invention, a method of recovering units of publication of digital files that have become inaccessible to a user who acquired the units of publication from a publisher using an original authorization code includes providing, by the user to the publisher via the publisher's website, an email address to which the original authorization code corresponding to at least one of the inaccessible units was sent by the publisher. The user provides the original authorization code to the publisher via the publisher's website. The user provides a backup copy of the inaccessible units corresponding to the original authorization code to the publisher via the publisher's website. The user initiates inactivation and replacement of the inaccessible units with the publisher. The user receives a new authorization code from the publisher at the email address. A digital storage device is registered using the new authorization code and a universal global identifier for the digital storage device. The user enters the authorization code at the publisher's website. The user requests inactivation and replacement of the inaccessible units at the publisher's website. The user receives a confirmation code from the publisher at the email address. The user enters the confirmation code at the publisher's website. The publisher inactivates the inaccessible units, and provides replacement units to the user.

Inactivating the inaccessible units by the publisher can include keeping a record, by the publisher, of available and unavailable units, and adding the inaccessible units to the unavailable units record, thereby rendering the inaccessible units unusable. The record kept by the publisher of available and unavailable units can be indexed by the unit serial number and can include the universal global identifier for each registered digital storage device associated with each available and unavailable unit. Providing the replacement units to the user by the publisher can include associating the universal global identifier for the replacement registered digital storage device with the backup copy of the inaccessible units, thereby creating the replacement units. The inaccessible units can then be moved from the unavailable units record to the available units record, thereby rendering the inaccessible units usable again.

The email address can be changed, for example, as follows. The user sends a reassignment request to the publisher. The publisher sends a confirmation code to the user at the email address. The user sends the confirmation code to the publisher through the publisher's website. The user sends an updated email address to the publisher. The publisher sends a confirmation code to the user at the email address. The user sends the confirmation code to the publisher through the publisher's website. The method can also include associating, by the user, the reassignment request with one or more units of publication assigned to the user, and associating, by the publisher, the new email address with the associated units. The method can also include associating, by the user, the reassignment request with all digital units assigned to the registered digital storage device and associated with the old email address, and associating, by the publisher, the new email address with all units assigned to the associated registered digital storage device and associated with the old email address.

The replacement units can include edits made to the units of publication as reflected in the backup copy.

Requesting, by the user to the publisher, inactivation and replacement of the inaccessible units can include checking, by the publisher, during inactivation and replacement of the inaccessible units, first, the IP address at use by the user, and, second, the universal global identifier of digital storage devices connected to the IP address, and providing replacement units to the user, by the publisher, can only be to the IP address and can only be used from a registered digital storage device that was connected to a computing device that was connected to the IP address during the Inactivation and Replacement process.

The method can also include providing the units of publication to the publisher by a producer. Registering the digital storage device using the new authorization code and a universal global identifier for the digital storage device can include determining a type of the digital storage device based on the universal global identifier, and restricting, by the producer and/or the publisher, provision of the replacement units to the user based on the determined type of the digital storage device. The type of the digital storage device can be, for example, a desktop computer, a laptop computer, a tablet device, and a peripheral memory device. If the digital storage device is a peripheral memory device, the method can also include registering, with the publisher by the producer, one or more computing devices for use with the peripheral memory device, and restricting, by the producer and/or the publisher, use of the peripheral memory device with only the registered one or more computing devices to access the units of publication. Registering the one or more computing devices for use with the peripheral memory device can include applying, by the producer, an authorization code obtained by the producer, using a producer email account that is inaccessible by the user or any other user. The registered digital storage device can include means for determining a physical location of the registered digital storage device, in which case the method can include restricting user access to the replacements units only within physical locations approved by the producer and/or the publisher. The method can also include providing, by the producer to the publisher, a restricted user list and/or a permitted user list, and provision of the units of publication can be restricted to users who are not on the restricted user list and/or users who are on the permitted user list.

### BRIEF DESCRIPTION OF THE DRAWINGS

FIG. 1 is a flow diagram of an exemplary embodiment of the invention.

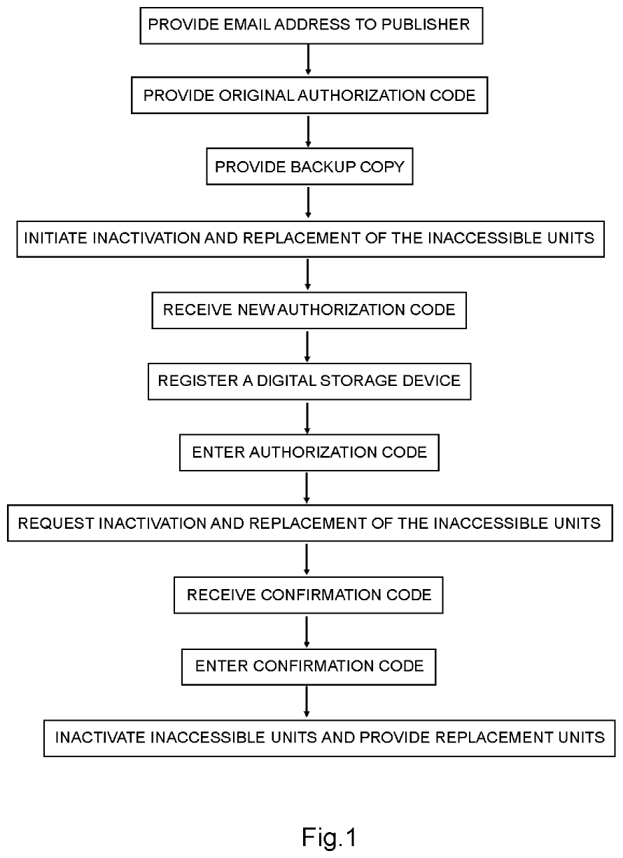

### DETAILED DESCRIPTION OF THE INVENTION

The method of the invention through further modification enables four additional aspects—three that have commercial potential alone, but one which has this, yet as well, has national economic security and defense potential.

The first three of the four aspects enable:
(a) Units of publication that were issued by a publisher under the method of the invention to be recovered automatically by a user through the publisher's website in the event that access to them has become impossible because of the loss or theft of, or because of the failure of the registered digital device to which these units are assigned.

In such case the user to recover the unavailable digital units will do the following:
(1) Provide through the publisher's website to the publisher an email address to which an authorization code corresponding to one or more lost digital units was sent by the publisher;
(2) Provide through the publisher's website this authorization code;
(3) Provide through the publisher's website a backup copy of the lost digital units which the user wishes to recover that correspond to this authorization code;
(4) Request inactivation and replacement of the lost digital units after receiving notification through the publisher's website that the Inactivation and Replacement process will cause the lost digital units to become unusable;
(5) Receive from the publisher at the email address a new authorization code;
(6) Register a replacement digital device using this authorization code;
(7) At the publisher's website enter the authorization code;
(8) At the publisher's website request inactivation and replacement of the lost digital units; and
(9) At the publisher's website enter a confirmation code sent to this email address.

When the above actions have been carried out, the publisher will inactivate and replace the original digital units with new digital units, as follows:

In the record of the unavailable units on the publisher's server, which record is organized according to the serial number of the units, the publisher's server alters the universal global identifier code for every unit that is to be replaced, changing the original code to the UGI code of the replacement digital device.

Then, through the method of the invention, the publisher's server creates replacement digital units from the submitted backup units, such that the alphanumeric code within each replacement unit corresponds to the UGI code for the replacement registered digital device, before downloading the replacement units to the computing device at use by the user.

The foregoing method may be repeated for each email address and for every authorization code that have been used to assign digital units to the unavailable registered digital device.

However, this method—which is automatic—requires that the user know the authorization codes employed to obtain the digital units that now are unavailable, and as well requires the user to have access to the email address to which these authorization codes were sent.

In cases where one or both conditions cannot be met, the publisher at its option may manually inactivate and replace the unavailable units by similar approach, after having confirmed that the request is valid—in particular, by confirming the identity of the requesting individual.

It is worth noting that if ever an inactivation and replacement need be reversed by the publisher, such as because inactivation and replacement was effected through fraud, it can be.

In circumstances where a user expects to lose access to an email address through which he has obtained digital units, in order to retain the ability to recover these units in the event of future loss or future failure of the registered digital device to which they are assigned, he may change the email address with which the units are associated, one at a time or in groups.

To change the email address with which a single digital unit is associated, the user may:
(1) After opening a digital unit in the proprietary digital unit reader associated with the invention, in the frame of the reader click a button labeled “Reassign”;
(2) In a dialogue box beside a blank where by the digital unit reader itself the email address with which the present digital unit is associated has been entered, click a button reading “Send Code”;
(3) In the same dialogue box, enter the confirmation sent to this email address, and click a button reading “Verify”;
(4) Enter a different email address and click a button reading, “Reassign”;
(5) Enter a confirmation code sent to the second email address, and click “Confirm”; and
(6) Click “OK” in a dialogue box reading, “Reassigned successfully!” Or, to change the email address with which one or more units are associated, the user may:
(1) In the frame of the digital unit reader, without having opened a digital unit, click the button labeled “Reassign.”
(2) In a dialogue box, select the present computing device, or select a digital storage device attached to the computing device, so long as the digital storage device selected is registered, to initiate the process of reassignment of all digital units assigned to the device, where the units are associated with a particular email address;
(3) Enter this email address and click “Send Code”;
(4) Enter the confirmation code sent to this address, and click “Verify”;
(5) Enter a different email address and click a button reading, “Reassign”;
(6) Enter a confirmation code sent to the second email address, and click “Confirm”; and
(7) Click “OK” in a dialogue box reading, “Reassigned successfully!”

In each case the result will be that in the publisher's record, the one or more digital units associated with a first email address will be assigned to a second email address, while each unit's serial number and authorization code will remain the same.

In a refinement of the Inactivation and Replacement process, which can be employed to enhance security, when the process is initiated, the user's IP address will be recorded by the publisher's server, and the process will not be completed unless the IP address when checked is the same—further, cannot be completed unless the registered digital storage device designated for storage of the replacement unit by the user is coupled for communication with the computing device at use during the Inactivation and Replacement process.

Under this modification, a user cannot use the I & R process digitally to transfer a unit to a user at another IP address. Where the modification is employed, the only way for an unauthorized user to access a digital unit is by possessing the registered digital device to which it is assigned.

A producer of digital units, to reduce the likelihood of transferal of a registered digital device to an unintended individual, may:
(1) Require that all digital devices to which digital units will be assigned by the producer be employed in a secure environment, such as a work building operated by the producer where individuals before departure from this building must permit their property to be inspected, for example;
(2) Decide that only computers, not tablet devices or USB memory sticks, and preferably not laptop computers, can be registered as digital devices to access the digital units the producer generates;
(3) Register, itself, all computers that authorized users may employ to access the producer's digital units;
(4) Register these computers by applying an authorization code that the producer has itself obtained, using an email account that no authorized user can access;
(5) Limit the Readers List of its publisher's website to readers it selects;
(6) Download, itself, the digital units that are to be accessed by authorized users, by employing authorization codes it obtained by using its secure email address; and
(7) Convey the digital units to the authorized users by any means, secure or insecure.

It is worth noting that under the I & R process, when a court in an appropriate jurisdiction has warranted that a law may have been broken, such as by the owner of a digital unit, if a copy of that digital unit can be obtained by the government authority investigating the alleged crime, the digital unit may be read on a digital unit reader after activation of the I & R process.

What is required for access to occur are, first, for the government authority to submit a copy of the digital unit to the unit's publisher, and the publisher, by means apparent to one of skill in the art, to determine the authorization code and email address associated with the unit, and, second, for this court or another court in a different jurisdiction to warrant access to that email account, so through this email address, the confirmation code that is required for the I & R process to be carried out can be obtained.

It is also worth noting that when through the I & R process a digital unit is inactivated and replaced, it retains all editing changes previously made by the user.

Thus, this aspect of the invention provides a method of recovering units of publication of digital files that have become inaccessible to a user who acquired the units of publication from a publisher using an original authorization code. These units could have become inaccessible because the storage device to which they were assigned has become inoperable or was stolen or lost, or because the files themselves have become corrupted, or for any other reason. The user requests replacement of the inaccessible units to the publisher, and also, preferably, inactivation of the inaccessible units.

This request, and the provision of supporting information by the user to the publisher, are provided at the publisher's website. The publisher uses a verification protocol to attain a certain level of confidence that the actual user is making the request.

In support of the request, the user provides information to the publisher via the publisher's website, both for security purposes and to provide the publisher with a basis for generating the replacement units. Thus, the user provides an email address to which the original authorization code corresponding to at least one of the inaccessible units was sent by the publisher, both to verify identity and to provide a path for communication during the replacement process. The user also provides the original authorization code to the publisher. The user also provides a backup copy of the inaccessible units corresponding to this original authorization code, as a starting point for the publisher to generate the replacement units. The backup copy can be an edited version or an unedited version of the units of publication. If the backup copy was edited, the replacement units preferably include the edits made to the units of publication as reflected in the backup copy.

As part of the replacement process, the user receives first a new authorization code and later a confirmation code from the publisher at the provided email address. Using the new authorization code, the user registers a digital storage device, using the unique universal global identifier for the digital storage device. This storage device can be the storage device on which the inaccessible units were stored, if it is still functioning, or it can be a different storage device. If the original storage device is used, it must be re-registered for storage of the replacement units in order for the replacement units to be received and used by the user. The user enters the authorization code and requests inactivation and replacement of the inaccessible units. The user receives and next enters the confirmation code at the publisher's website. If the confirmation is determined to be correct by the publisher, the publisher provides the replacement units to the user and also preferably inactivates the inaccessible units.

In order to inactivate the inaccessible units, the publisher can, for example, keep a record of available and unavailable units, and can add the inaccessible units to the unavailable units record to render the inaccessible units unusable after Inactivation and Replacement. Hence, someone who has stolen or found the inaccessible units would be unable to open or otherwise access these units of publication after I & R, as now any authentication process involving these units would be deemed invalid. The record kept by the publisher of available and unavailable units preferably is indexed by publication unit serial number and includes the universal global identifier for each registered digital storage device associated with each available and unavailable unit, so as to link availability to the storage device. As the publisher creates and provides the replacement units to the user, the publisher associates the universal global identifier for the replacement registered digital storage device with the backup copy of the inaccessible units (in encrypted form, as disclosed elsewhere) to create the replacement units. The inaccessible units, as represented by the modified backup copy, then is moved from the unavailable units record to the available units record in order to render the inaccessible units usable again.

The process described above assumes that the email address originally provided by the user to the publisher to obtain the units of publication is the same email address used by the user when requesting the replacement units. Because a user's email address can be changed over time and because the user's original email address might itself be inaccessible at a later date, the email address associated with the units of publication by the publisher can be updated. For example, the user can send a reassignment request to the publisher, preferably when the user still has access to the original email address. The publisher then sends a confirmation code to the user at that email address. The user sends the confirmation code to the publisher from the original email address to confirm identity, and then sends the updated email address to the publisher. The publisher then sends a confirmation code to the user at the updated email address, and the user sends the confirmation code back to the publisher from the updated email address. Once receiving confirmation of the change, the publisher can update the email address for the user.

In certain circumstances, the user might only desire to update the email address associated with certain particular units of publication, and not with all units of publication possessed by the user. In this case, the updating process, as part of the update request, the user can also associate the reassignment request with one or more selected units of publication assigned to the user, and the publisher can associate the updated email address with only the associated units. Likewise, the user can associate the reassignment request with respect to all digital units targeted to a particular designated registered digital storage device, and the publisher can associate the updated email address only with respect to all digital units targeted to the designated registered digital storage device through the original email address. Thus, in general, the user can update email addresses for all user units of publication, or for any grouping of units such as based on where the units are assigned for storage, or for any individual units.

The provision of replacement units can further be limited by the publisher, based on other factors, such as location, device, or any identifiable factor. For example, when the user requests inactivation and replacement of the inaccessible units, the publisher can check the IP address at use during the Inactivation and Replacement process, and check the universal global identifier of the digital storage device or devices connected to the computing device at use, and can restrict provision of replacement units to the user only to that IP address, with assignment of replacement units only to a registered digital storage device connected to the IP address during the Inactivation and Replacement process. Restrictions based on GPS data, time periods, or any other factors can similarly be implemented, to protect the interests of the publisher, or those of a content producer, as described below.

Before units of publication can be provided to a user by a content producer, they must be provided to the publisher by the content producer. The restrictions placed by the publisher on distribution described above, as well as others, can also be specified by the producer, and can be enforced by the producer as part of the digital file of the publication units when created by the producer, or can be enforced by the publisher as specified by the producer.

For example, either the producer or the publisher, or both, can specify the type of digital storage device that can be registered, or that can be registered to store a particular unit of publication. That is, the restriction can be global, such as a restriction placed by the publisher for all device registrations, or can be very particular, such as when a producer wants a restriction on the storage of a particular publication or unit of content. Nesting and overlapping restrictions by the producer and the publisher provide a granularity of potential storage rules for flexible security. In order to implement these rules, the type of the digital storage device can be determined, for example, based on the universal global identifier of the device, and use of the device for storage of units of publication, including for provision of replacement units to the user, can be allowed or disallowed by the producer and/or the publisher based on the determined type of the digital storage device. Examples of types of digital storage devices include the internal memory of desktop computers, laptop computers, and tablet devices, as well as peripheral memory devices and even cloud storage.

Similarly—in particular if the registered digital storage device to which units of publication are assigned is a peripheral memory device—it can be required that one or more computing devices must be registered for use with the units of publication and/or with the peripheral memory device, use of the units of publication and/or the registered digital storage device then being solely with the one or more computing devices designated by the producer and/or the publisher. Registering the one or more computing devices for use with the units of publication and/or with the registered digital storage device can include, for example, applying, by the producer in order to acquire the units of publication, an authorization code that has been obtained by the producer using a producer email account that is inaccessible by the user or any other user.

Using GPS tracking or other means, a physical location of the registered digital storage device can be determined, and user access to the replacements units or any other units of publication can be restricted only to within physical locations approved by the producer and/or the publisher. Other restrictions, such as those based on a restricted user list and/or a permitted user list, based on time of day, based on duration of use, or based on any other parameter or factor can be similarly implemented.
(b) By use of a digital unit presentation app, similar to the PowerPoint® computer application and other similar applications, created items of various types that now are components of a digital unit published under the method of the invention, which items by the intent of the copyright holder should not enter the public domain—these items including artworks of various types, photographs, sound recordings, movies, cartoons, tables or formatted lists, and PDF's, as non-limiting examples—can be copied and pasted into another digital unit, while not being able to be copied or pasted in any way, otherwise.

Particularly, to create this presentation app, the digital unit reading app is modified in the following ways:

First, the reading app is modified to allow the copying and pasting of created items only, which is to say, not to allow copying or pasting of text—the reading app not permitting any copying or pasting at all—however, then, second, is modified such that these functions occur in a “non-standard way,” that is, with copying not to the clipboard of the user's computing device, but to a “local clipboard” maintained by the presentation app, and with pasting of items from the local clipboard only to a further digital unit.

Preferably, a user to create a presentation will initiate the action by opening a special digital unit created for this purpose, whose pages will all be blank.

The only editing functions that may be performed by the digital unit presentation app are copying and pasting; still, though, digital units formed with the presentation app will be operable in the reading app, and thereby, every editing function afforded by the invention is available.

Preferably, when creation of a presentation has been completed, it will be displayed by the presenter through the reading app, since in particular, this allows the addition of typed text and handwriting and drawing by the presenter during the presentation, which can make the digital unit function “like a real-time electronic blackboard.”
(c) By a handwriting function of the editing function of the digital unit reading app, users may enter handwritten notes and drawings with electronic pen, stylus, mouse, or other input device, into a digital unit.

Preferably, a user's handwriting is entered in a blank handwriting entry window—where when this approach is used, after the saving of this window, that window when opened by a user preferably will be smaller than the corresponding page and partially overlay that page or, alternately, lie beside that page.

At later use of the unit, a user on a current page may instantaneously open the handwriting window, and may subsequently instantaneously close the handwriting window, in either case by clicking with his mouse, in the first case on an activated element in the departure page, and in the second case preferably in an “x” in the upper right-hand corner of the frame of the handwriting window, or, alternately, anywhere within the handwriting window.

This approach to entering handwriting is activated by a user when he highlights a section of text or highlights a blank space in the editing window before activating the handwriting function to open the handwriting entry window.

The fourth aspect enables digital units still to be opened if the internet has gone down temporarily or permanently, if a publisher's server has been disrupted, such as by being hacked, or if operation of a publisher's server has been eliminated, such as by the publisher's going out of business.

This aspect involves the following modifications to the method of the invention:
(1) Two of the three classes of data that must be checked by the reading app before a digital unit can be opened by a user are regularly backed up by the publisher's server. The two data classes are the serial number of the digital unit, and the UGI of the registered digital device to which the digital unit is assigned. The third class of identifying data held by the publisher for every digital unit it produces, i.e., an alphanumeric which is assigned to the digital unit, and which corresponds to the UGI of the registered digital device to which the digital unit is assigned, need not be backed up for the user's opening of a digital unit to be validated when the internet has gone down, because the alphanumeric corresponds to the UGI algorithmically, and furthermore because this alphanumeric and the UGI are compared by the computing device at the request of the user's reading app without the internet. Preferably, modification of the backup file by the publisher occurs whenever a digital unit is created or whenever a digital unit is assigned from a current registered digital device to another registered digital device.
(2) The serial number and UGI backup data are stored by the publisher more securely than in the cloud, preferably being stored on an electronic storage device enclosed within a Faraday cage or on an optical disc.
(3) When the internet has gone down and a user wishes to validate the opening of a digital unit, once the algorithmic data check has been conducted successfully, whether the UGI of the device on which the user's digital unit is stored is the “current” UGI can be checked by the user's reading app by non-internet means, which in descending order of preference follow: (a) In regions where copper-line telephone service is still in use, the necessary UGI currency check will be conducted by the reading app by communicating with the publisher's server by analog modem. (b) If analog modem service is unavailable, the UGI will be sent by the reading app to the publisher's server and back, through a cellphone service. (c) If where a user is, the internet and cellphone service together have failed, the UGI currency check will be carried out by the user's reading app by the consultation of a serial number and current UGI database that has been made available to users in a non-modifiable form, such as on a CD, and then been attached by the user to the user's computing device.
(4) Where a publisher's server is expected be taken out of service, the “CD approach” discussed above may be employed to allow a user to validate the opening of a digital unit by the digital unit reading app, or in an alternate approach, the present publisher may give or sell its serial number and UGI database to a successor publisher, for the latter to use to validate the opening of digital units by users.
(5) If the internet is operating, but the publisher's server has failed, such as because this server has been hacked, a partial temporary replacement server may be set up by this publisher to allow users to validate the opening of digital units—the replacement server storing at a minimum the publisher's serial number and UGI database, and as well software which will allow UGI's to be checked for currency, and software that permits the communication of a “pass” or “fail” message to the user's IP address and computing device in response to a request from the user's digital reading app for digital unit opening validation.

Particular exemplary embodiments of the present invention have been described in detail.

These exemplary embodiments are illustrative of the inventive concept. For example, particular application interface details and user input actions and sequences have been described to facilitate disclosure of the broader aspects of the invention; the disclosed interface details (for example, dialog box and action button names, text, and other details) and disclosed actions (for example, computing interface actions implemented by a user to advance the steps of the broader flow of the method of the invention) are exemplary only, and equivalents to the same as understood by one of skill in the art are intended to be included within the scope of the invention. The disclosure should be given its broadest interpretation to encompass any equivalents of all aspects of the invention as disclosed, as should any future claims supported by the present disclosure.

I claim:

1. A method of recovering units of publication of digital files that have become inaccessible to a user who acquired the units of publication from a publisher using an original authorization code, comprising:
providing, by the user to the publisher via the publisher's website, an email address to which the original authorization code corresponding to at least one of the inaccessible units was sent by the publisher;
providing, by the user to the publisher via the publisher's website, the original authorization code;
providing, by the user to the publisher via the publisher's website, a backup copy of the inaccessible units corresponding to the original authorization code;
initiating, by the user with the publisher, inactivation and replacement of the inaccessible units;
receiving, by the user from the publisher at the email address, a new authorization code;
registering a digital storage device using the new authorization code and a universal global identifier for the digital storage device;
entering, by the user at the publisher's website, the authorization code;
requesting, by the user to the publisher, inactivation and replacement of the inaccessible units;
receiving, by the user from the publisher at the email address, a confirmation code;
entering, by the user at the publisher's website, the confirmation code; and
inactivating the inaccessible units, and providing replacement units to the user, by the publisher.

2. The method of claim 1, wherein inactivating the inaccessible units by the publisher, includes:
keeping a record, by the publisher, of available and unavailable units; and
adding the inaccessible units to the unavailable units record, thereby rendering the inaccessible units unusable.

3. The method of claim 2, wherein the record kept by the publisher of available and unavailable units includes the universal global identifier for each registered digital storage device associated with each available and unavailable unit.

4. The method of claim 3, wherein the record kept by the publisher of available and unavailable units is indexed by unit serial number.

5. The method of claim 3, wherein providing the replacement units to the user by the publisher includes associating the universal global identifier for the registered digital storage device with the backup copy of the inaccessible units, thereby creating the replacement units.

6. The method of claim 2, further comprising moving the inaccessible units from the unavailable units record to the available units record, thereby rendering the inaccessible units usable again.

7. The method of claim 1, further comprising changing the email address, including:
sending, by the user, a reassignment request to the publisher;
sending, by the publisher, a confirmation code to the user at the email address;
sending, by the user, the confirmation code to the publisher through the publisher website;
sending, by the user, an updated email address to the publisher;
sending, by the publisher, a confirmation code to the user at the email address;
sending, by the user, the confirmation code to the publisher through the publisher website.

8. The method of claim 7, further comprising:
associating, by the user, the reassignment request with one or more units of publication assigned to the user; and
associating, by the publisher, the new email address with the associated units.

9. The method of claim 7, further comprising:
associating, by the user, the reassignment request with the registered digital storage device; and
associating, by the publisher, the new email address with the associated registered digital storage device.

10. The method of claim 1, wherein the replacement units include edits made to the units of publication as reflected in the backup copy.

11. The method of claim 1, wherein:
requesting, by the user to the publisher, inactivation and replacement of the inaccessible units includes:
checking, by the publisher, an IP address used during the request;
checking by the publisher the universal global identifiers of all digital storage devices connected to the IP address through the computing device in use by the user; and
providing replacement units to the user, by the publisher, only to the IP address, and only to a registered digital storage device that has been connected to the IP address through the computing device since the request.

12. The method of claim 1, further comprising providing the units of publication to the publisher by a producer.

13. The method of claim 12, wherein
registering the digital storage device using the new authorization code and a universal global identifier for the digital storage device includes determining a type of the digital storage device based on the universal global identifier; and
restricting, by at least one of the producer and the publisher, provision of the replacement units to the user based on the determined type of the digital storage device.

14. The method of claim 13, wherein the type of the digital storage device is one of desktop computer, laptop computer, tablet device, and peripheral memory device.

15. The method of claim 14, wherein the digital storage device is a peripheral memory device, the method further comprising:
registering, with the publisher by the producer, one or more computing devices for use with the peripheral memory device; and
restricting, by at least one of the producer and the publisher, use of the peripheral memory device with only the registered one or more computing devices to access the units of publication.

16. The method of claim 15, wherein registering the one or more computing devices for use with the peripheral memory device includes applying, by the producer an authorization code obtained by the producer, using a producer email account that is inaccessible by the user.

17. The method of claim 12, wherein:
the registered digital storage device includes means for determining a physical location of the registered digital storage device; and
the method further includes restricting user access to the replacements units only within physical locations approved by at least one of the producer and the publisher.

18. The method of claim 12, further comprising:
providing, by the producer to the publisher, at least one of a restricted user list and a permitted user list; and
restricting provision of the units of publication to at least one of users who are not on the restricted user list and users who are on the permitted user list.
